(19) United States
(12) Patent Application Publication
(10) Pub. No.: US 2004/0230321 A1
(43) Pub. Date: Nov. 18, 2004

(54) Operating panel configuration for an electrical demestic appliance

(76) Inventors: Dirk Golz, Wroclaw (PL); Fritz Siebachmeyer, Neukrich (DE)

Correspondence Address: LERNER AND GREENBERG, P.A., POST OFFICE BOX 2480, HOLLYWOOD, FL, 33022-2480, US

(21) Appl. No.: 10/706,823

(22) Filed: Nov. 12, 2003

(30) Foreign Application Priority Data
Dec. 14, 2002 (DE) 102 58 563.6

(51) Int. Cl. G05B 11/01

(52) U.S. Cl. 700/17

(57) ABSTRACT

An operating panel configuration for an electrical domestic appliance such as a washing machine or the like. The panel configuration has an operating panel and an associated control circuit with operating and/or control and/or switching and/or display elements. The operating panel is provided with a single opening for the control circuit and the control circuit is in the form of a functional unit with all operating and/or control and/or switching and/or display elements. A front side of the control circuit is adapted in respect of design to the front side of the operating panel. The control circuit is preferably in the form of a control module.

### BACKGROUND OF THE INVENTION

### FIELD OF THE INVENTION

The invention concerns an operating panel configuration for a large electrical domestic appliance. The large domestic electrical appliance may be a washing machine, for example.

In known washing machines the operating panel configuration usually has two panel regions, more specifically a relatively short panel region for the addition of a washing agent and a panel region which is long in comparison therewith and which is combined with the program, that is to say control circuit. The control circuit is usually integrated into the panel region, that is to say into the operating region of the large domestic appliance, wherein a distinction is to be drawn between the functional region associated with the control, which concerns control procedures, and the design region which is associated with the panel. The control, that is to say the control circuit, is disposed on the rear of the operating panel—in such a way as to be invisible from the exterior—, wherein the operating panel has various openings for operating and/or control and/or switching and/or display elements. The control circuit is actuated by the operating and/or control and/or switching elements which involve buttons, switches, rotary control members or the like. The display elements serve for example for displaying the respective program status. Additional mechanical functional elements such as for example pushrods, pushbutton caps, return springs, rotary knobs, spindle elements, light guides, filters and so forth are hitherto either integrated into the operating panel or are disposed in the intermediate space between the operating panel and the control circuit. The overall system formed of the control circuit, the operating panel and the operating and display elements therefore hitherto contains a large number of individual parts, in which respect the control circuit—including its housing if provided—are scarcely visible or are not visible at all, to the exterior. That for example also applies in regard to the operating panel known from Published European Patent Application EP 1 128 510 A2 for a large electrical domestic appliance. The known operating panel has a frame portion, on the front side of which is disposed a decorative panel and on the rear side of which is disposed a circuit board with the operating, control, switching and/or display elements. The operating elements project through the frame portion and through openings in the decorative panel at the front side so that, with the known operating panel, it is also necessary for the decorative panel to be matched with its openings to the respective circuit board.

Operating panels and decorative panels of the above-specified kind involve relatively large components that require correspondingly cost-intensive injection molding apparatuses. Consequently, cost-intensive injection molding apparatuses of that kind are only suitable for producing large numbers of units of operating and decorative panels.

### SUMMARY OF THE INVENTION

It is accordingly an object of the invention to provide an operating panel configuration for an electrical domestic appliance that overcomes the above-mentioned disadvantages of the prior art devices of this general type, in which all functions, namely the control and configuration functions, can be implemented without the involvement of the operating panel.

With the foregoing and other objects in view there is provided, in accordance with the invention, an operating panel configuration for an electrical domestic appliance. The operating panel configuration contains a control circuit being a functional unit having operating, and/or control, and/or switching, and/or display elements. The control circuit has a circuit front side. An operating panel has a single opening that receives the control circuit. The operating panel has a panel front side adapted to a configuration of the circuit front side of the control circuit.

The operating panel configuration according to the invention has the advantage of a compact structure, wherein, in a particularly advantageous manner, besides its control functions, the control circuit also has configuration features that substantially contribute to the aesthetics of the overall look of the large electrical domestic appliance in the operating region. The operating panel of the operating panel configuration according to the invention can be in the form of a standard component, with the functional and configuration-determining features being concentrated on the control circuit. This is appropriate for the reason that usually function and configuration are linked together and a desired variant configuration only needs to be affected on one component, namely the control circuit. A further substantial advantage is that overall assembly is substantially simplified as a consequence of handling comparatively few components, namely the operating panel and the control circuit with all the operating and/or control and/or switching and/or display elements. The reduction in the number of components also has an advantageous effect in logistical areas.

In accordance with the invention it is preferred if the control circuit is in the form of a module in which all functions which are relevant in terms of control procedures and all operating and display elements, including their mechanical and optical functional elements, are integrated. This gives the advantage that the respective module can be subjected to functional testing without the operating panel which is to be combined with the module being present at or having to be present at the manufacturer of the module.

If the power switch is also integrated into the module, this gives the advantage that the cabling complication and expenditure is substantially simplified in comparison with a conventional control concept with a separate power switch.

In accordance with the invention the control circuit is in the form of a complete functional unit, wherein all functions which are relevant in terms of control procedures as well as all operating and display elements including their mechanical and optical functional elements are integrated into the control module and the module casing or the module is of such a configuration at its front side that the front side of the module is adapted to the configuration of the operating panel. The control module is mounted in the operating panel of the large electrical domestic appliance in such a way that its front side that is adapted to the operating panel configuration substantially determines the configuration of the overall operating panel configuration or the electrical domestic appliance.

It has proven to be desirable if the front side of the module has a surface region for items of information. The information region can be a region with text and/or with symbols. In a comparatively simple configuration of the electrical domestic appliance, this may involve for example printing thereon text and/or symbols such as operating instructions or the like. In an exemplary embodiment, the information region can have a display for items of changing information such as for example the corresponding program procedure.

Other features which are considered as characteristic for the invention are set forth in the appended claims.

Although the invention is illustrated and described herein as embodied in an operating panel configuration for an electrical domestic appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, exploded, perspective view of a known operating panel configuration; and

FIG. 2 is a perspective view of the operating panel configuration according to the invention, which functionally corresponds to the operating panel configuration shown in FIG. 1.

### DESCRIPTION OF THE PREFERRED EMBODIMENTS

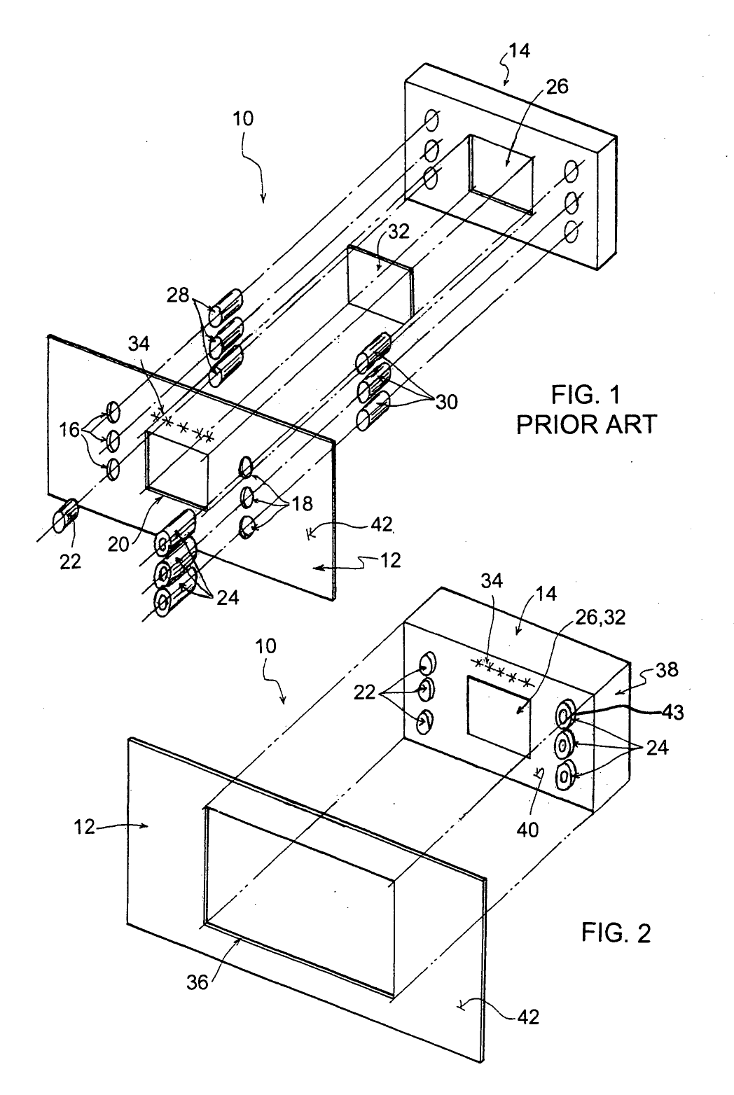

Referring now to the figures of the drawing in detail and first, particularly, to FIG. 1 thereof, there is shown a diagrammatic, exploded perspective view of an operating panel configuration 10 containing an operating panel 12 and a control circuit 14. The operating panel 12 has holes 16, 18 and 20. The holes 16 are intended for example for pushbuttons 22, of which only one is shown in FIG. 1. The holes 18 are provided for example for rotary knobs 24. The hole 20 is provided for an optical display element 26 of the control circuit 14.

The pushbuttons 22 are mechanically coupled to the control circuit 14 by pushrod members 28. The rotary knobs 24 are operatively connected to the control circuit 14 by shaft members 30.

The optical display element 26 of the control circuit 14 is combined with a light waveguide or filter 32.

The operating panel 12 has an information region 34 that for example is printed with text such as operating instructions and/or with symbols.

As will be readily apparent from FIG. 1, in such a known operating panel configuration 10 the entire system formed of the control circuit 14, the operating panel 12 and the operating and display elements 22, 24, 26 involves a large number of parts, while the control circuit 14 is scarcely visible or is not visible relative to the exterior. The control circuit 14 consequently does not contribute to the overall aesthetics of the respective large electrical domestic appliance, in the operating region.

The situation is different in the case of the operating panel configuration 10 according to the invention as shown in FIG. 2 for a large electrical domestic appliance such as for example a washing machine. The operating panel configuration 10 has the operating panel 12 with an opening 36 for the control circuit 14 that is in the form of a control module 38. The control module 38 forms a functional unit with all operating and/or control and/or switching and/or display elements. In other words, the pushbuttons 22, the rotary knobs 24 and the optical display element 26 with the filter 32 are integrated into the control module 38. A power switch 43 is preferably also integrated into the control module 38.

The control module 38 has a front side 40 that is adapted in respect of its configuration to a front side 42 of the operating panel 12.

In the configuration of the operating panel configuration 10 according to the invention it is not the front side 42 of the operating panel 12 but the front side 40 of the control module 38 that is provided with an information region 34. The control module 14 as shown in FIG. 2 consequently forms a unit that can be checked in respect of function, independently of the operating panel 12.

In the operating panel configuration 10 according to the invention all operating and display elements including associated mechanical functional elements are integrated into the control module 38 so that the control module 38 represents what is referred to as a ‘stand-alone’ (complete in itself) functional unit. The power switch 43, that is to say the operating switch, can also be integrated into that functional unit. The functional unit, that is to say the control module 38, is so configured at its front side 40 that it is adapted to the configuration of the front side 42 of the operating panel 12. The front side 40 can be for example varnished or painted or printed upon so that the control module 38 can involve aesthetic functions. The operating panel 12 of the operating panel configuration 10 according to the invention, instead of a plurality of openings, has only one single relatively large opening 36 in which the control module 38 with its multiple functions is mounted. The single relatively large panel opening 36 is adapted in its configuration to the front side 40 of the control module 38.

We claim:

1. An operating panel configuration for an electrical domestic appliance, the operating panel configuration comprising:
a control circuit being a functional unit having at least one component selected from the group consisting of operating elements, control elements, switching elements, and display elements, said control circuit having a circuit front side; and
an operating panel having a single opening formed therein receiving said control circuit, said operating panel having a panel front side adapted to a configuration of said circuit front side of said control circuit.

2. The operating panel configuration according to claim 1, wherein said control circuit is a control module in which all functions which are relevant in terms of control procedures and all operating and display elements including mechanical and optical functional elements are integrated.

3. The operating panel configuration according to claim 2, further comprising a power switch integrated into said control module.

4. The operating panel configuration according to claim 2, wherein said circuit front side of said control module is adapted to said panel front side.

5. The operating panel configuration according to claim 2, wherein said control front side of said control module has a region for information.

6. The operating panel configuration according to claim 5, wherein said region is provided with at least one of text and symbols.

7. The operating panel configuration according to claim 5, wherein said region has a display for changing items of information.

8. The operating panel configuration according to claim 1, wherein:
said component is one of a plurality of components forming said control circuit; and
said operating panel does not contain any of said components.
